(19) United States
(12) Patent Application Publication
(10) Pub. No.: US 2004/0182908 A1
(43) Pub. Date: Sep. 23, 2004

(54) Power tool for metal piercing fasteners

(75) Inventors: Mark A. Farrell, Conroe, TX (US); Michael E. Farrell, Murrieta, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(73) Assignee: EVENING STAR INTERNATIONAL, LLC

(21) Appl. No.: 10/393,701

(22) Filed: Mar. 21, 2003

(51) Int. Cl. B25C 5/02

(52) U.S. Cl. 227/119

(57) ABSTRACT

A power tool for installing metal piercing fasteners being characterized by a body bent at one end to form a crown portion and having at least one side guide rail and at least one integral tine under the crown portion, the integral tine being deformed about its longitudinal axis to cause at least one portion of the tine to protrude outwardly from the body of the fastener comprises a fastener guide body including at least one guide channel adapted to accommodate the side guide rail of the metal piercing fastener. The guide channel defines a linear drive path for the metal piercing fastener. The power tool also comprises a fastener driver body including at least one outwardly protruding side spline adapted to conform approximately to the outer contours of the side guide rail of the metal piercing fastener and to slide within the trajectory channel, and a fastener driver tip for forcibly impacting the crown portion of the metal piercing fastener. The fastener driver tip is coupled to one end of the fastener driver body and adapted to follow approximately the outer configuration of the fastener driver.

### RELATED APPLICATIONS

The present application is related to co-pending U.S. patent application, entitled “FASTENER HAVING GUIDE RAILS” having the same inventors and assignee, attorney's docket No. 6878-111XX/10214004, the disclosure of which is incorporated in its entirety herein by reference.

### FIELD OF THE INVENTION

The present invention relates generally to power tools and more particularly to a power tool for use with metal piercing fasteners having an elongated flat body with one end bent to form a crown and a guide rail along at least one side edge thereof.

### BACKGROUND OF THE INVENTION

Securing work pieces together, such as, for example, a top laminate non metal work piece to a bottom light-gauge metal substrate (18 gauge and thinner) or alternatively, a light gauge metal work piece to light-gauge metal substrate has generally been accomplished by threaded fasteners. The helical design of the thread has been generally successful in pulling the top laminate materials together tightly with the light-gauge metal substrate. Additionally, the helical thread design has provided sufficient withdrawal resistance to achieve performance values acceptable to the construction industry. However, installation of helical threaded fasteners with traditional rotary power tools has proven time-consuming to the installer. The industries using these light-gauge metals would be better served by a fastener power tool having the speed of a pneumatic nailing system and being adapted for use with metal piercing fasteners having the gripping and clamping capabilities of helical threaded fasteners.

Pneumatic nailing and power tools are well known in the prior art. Typical examples of such known pneumatic nailing power tools are disclosed in U.S. Pat. Nos. 4,384,623; 5,135,152; 6,155,472; 6,318,618; 6,431,428; and 5,074,453. These structures illustrate various types of power tools for driving nails, metal staples and similar such articles. Typically, these devices include a compressed gas source which drives a piston which in turn, moves a driver into engagement with the fastener device positioned within the drive channel of the tool to cause the fastener to enter the workpiece which is typically wood.

The most pertinent of the patents above referred to is U.S. Pat. No. 5,074,453 which discloses a pneumatic fastener driving tool for driving a fastener which is formed from an elongated cylindrical rod having a straight leg, a curved head and a bent end portion to drive a hook-shaped fastener into a workpiece. The driving end portion of the tool disclosed in the 5,074,453 patent is designed to provide guide surfaces which engage the leg and the bent end portion of the fastener during the driving operation to prevent the fastener from bending or entering the workpiece at an angle. Applicant is aware of fasteners having elongated flat bodies with the end portion thereof bent over to form a head or crown to thus form sheet metal roofing nails as disclosed in U.S. Pat. Nos. 2,740,505 (Flora); 2,751,052 (Flora); and 3,983,779 (Dimas). These sheet metal roofing nails are designed to be installed manually by hammering them through a layer of insulation and into a metal roofing material. Applicants are unaware of any power tool adapted to install a fastener formed from an elongated flat body, with the end bent to form a crown, into a workpiece including a light gauge metal substrate.

### SUMMARY OF THE INVENTION

The present invention is generally directed to a power tool for installing metal piercing fasteners comprising a fastener guide body including at least one guide channel adapted to accommodate the outer contours of an elongated flat metal piercing fastener, the guide channel defining a linear drive path for the metal piercing fastener which fastener has a guide rail along one side edge thereof, and a fastener driver body adapted to slide within the guide channel behind the metal piercing fastener for the purpose of forcibly impacting the metal piercing fastener.

### BRIEF DESCRIPTION OF THE DRAWINGS

The invention is generally shown by way of example in the accompanying drawings in which:

FIG. 1 is a side perspective view of a power tool for installing metal piercing fasteners into a plurality of laminar workpieces including a metal substrate to join the workpieces together in accordance with one embodiment of the present invention;

FIG. 2 is a partial perspective view of the power tool of FIG. 1;

FIG. 3 is a side view of a fastener load mechanism of the power tool of FIG. 1;

FIG. 4 is a front view of a fastener guide mechanism of the power tool of FIG. 1;

FIG. 5 is a back view of the fastener guide mechanism of FIG. 4;

FIG. 6 is a top view of the fastener guide mechanism of FIG. 4;

FIG. 7 is a cross-sectional view of a fastener guide body of the fastener guide mechanism of FIG. 4 in accordance with one embodiment of the present invention;

FIG. 8 is a partial bottom perspective view of the fastener guide mechanism of FIG. 4 in accordance with one embodiment of the present invention;

FIG. 9 is a side perspective view of one component of a fastener drive mechanism of the power tool of FIG. 1;

FIG. 10 is a side perspective view of another fastener drive mechanism component of the power tool of FIG. 1;

FIG. 11 is a side perspective view of yet another fastener drive mechanism component of the power tool of FIG. 1;

FIG. 12 is a front perspective view of a metal piercing fastener being driven by a fastener drive mechanism of the power tool of FIG. 1 in accordance with one embodiment of the present invention; and

FIG. 13 is a perspective illustration of a metal piercing fastener for use with the power tool of the present invention.

### DETAILED DESCRIPTION OF THE PREFERRED EMBODIMENTS

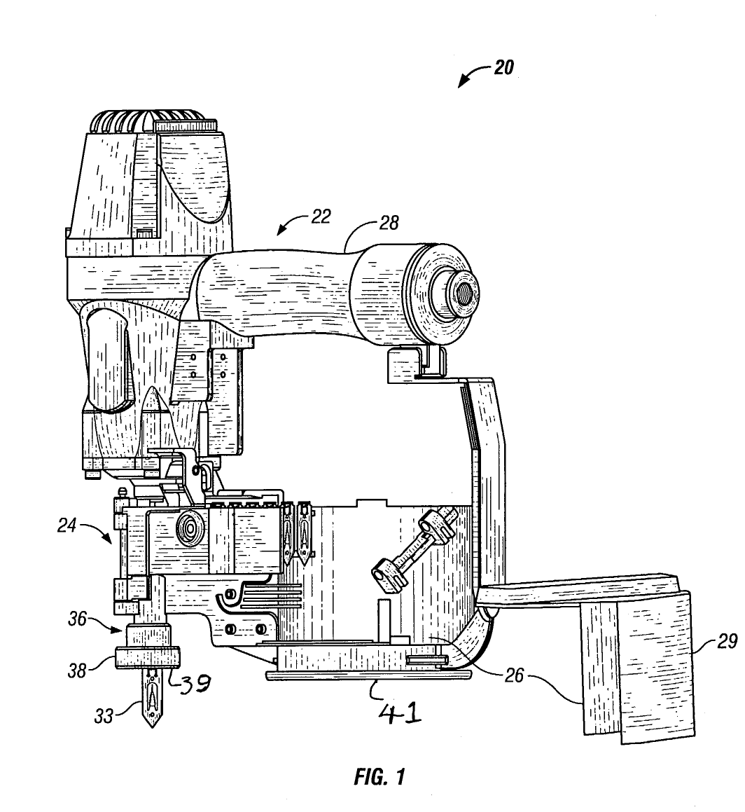

Hereinafter, some preferred embodiments of the present invention will be described in detail with reference to the related drawings of FIGS. 1-13. Additional embodiments, features and/or advantages of the invention will become apparent from the ensuing description or may be learned by practicing the invention.

The drawings are not to scale with like numerals referring to like features throughout both the drawings and the description.

The following description includes the best mode presently contemplated for carrying out the invention. This description is not to be taken in a limiting sense, but is made merely for the purpose of describing the general principles of the invention.

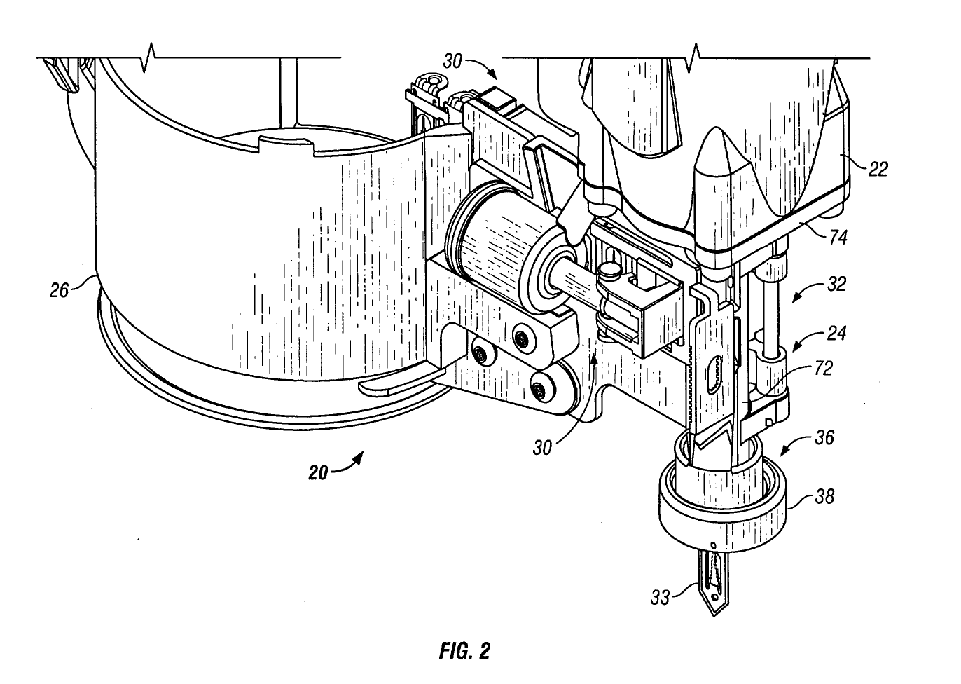

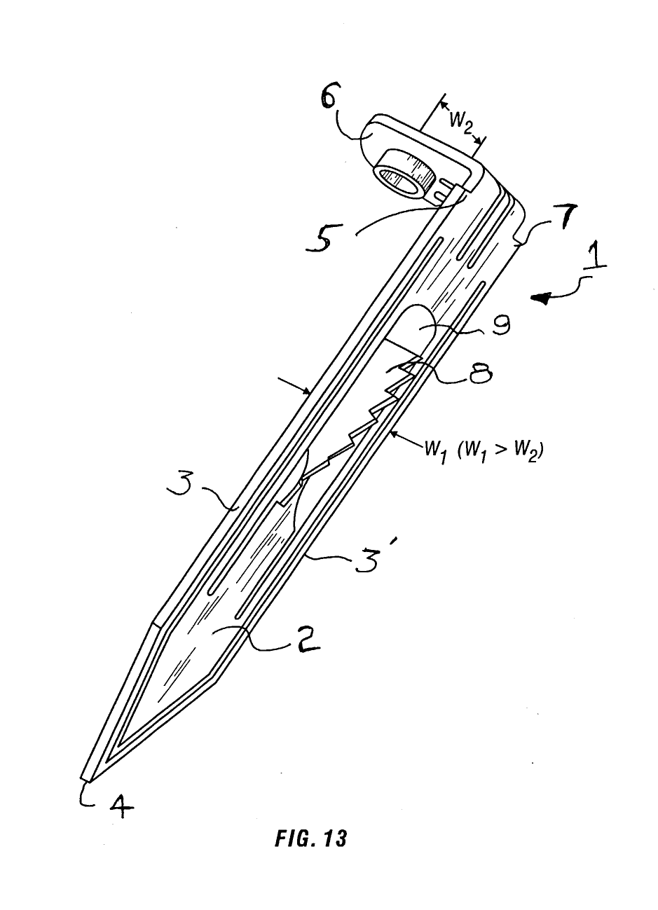

Turning to FIGS. 1-2, a power tool 20 for installing metal piercing fasteners (of the type disclosed in co-pending U.S. patent application, entitled “FASTENER HAVING GUIDE RAILS” having the same inventors and assignee, attorney's docket No. 6878-111XX, the disclosure of which is incorporated herein by reference) into a plurality of laminar workpieces (at least one of which is a metal substrate) to secure the same together. The fastener as disclosed in the above-identified pending application is shown in FIG. 13 to which reference is hereby made. The fastener 1 as therein illustrated includes an elongated body 2 having a point 4 for penetrating the workpiece and the metal substrate provided at the opposite end of the elongated body 2 is a head 6 which is formed by bending over one end of the body 2. The head 6 is adapted for engagement by a power tool constructed in accordance with the present invention to drive the fastener 1 through the workpiece and the metal substrate. A securing member 8 is carried by the body 2 for securing the workpiece and the metallic substrate together after insertion of the fastener. The securing member 8 as illustrated in FIG. 13 is a tine which is disposed within an opening 9 formed in the body 2. The tine extends from the lower portion of the opening and protrudes upwardly into it. As is shown in FIG. 13, the tine is deformed about its longitudinal axis as it passes through the aperture formed by the point 4 it flattens into the opening 9 and does not distort the aperture dimensions. The securing member then by friction from the edges locking within the formed aperture holds the workpiece and the metal substrate together. The body 2 of the fastener 1 has a width dimension W1 and the head 6 has a width dimension W2. The width dimension W1 of the body is greater than the width dimension W2 of the head. As a result, a pair of guide rails 5 and 7 are provided along the two side edges 3 and 3′, respectively, of the body 2. These guide rails 5 and 7, as will be discussed in more detail below, cooperate with guide channels provided in the power tool to maintain the fastener 1 substantially perpendicular to the surface of the workpieces at all times during installation of the fastener 1 into the workpieces.

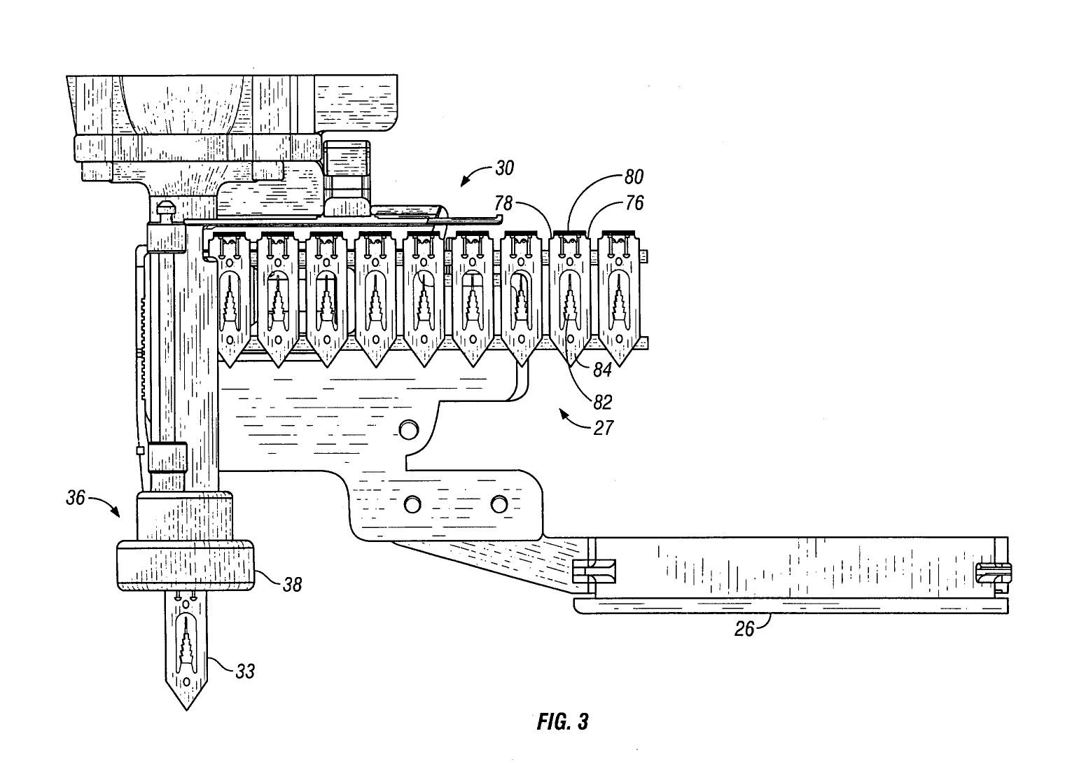

The power tool 20 comprises a housing 22, a barrel portion 24 coupled to the housing 22, and a magazine 26 coupled between barrel portion 24 and the housing 22. Magazine 26 (FIGS. 1-2) is of a generally hollow cylindrical configuration adapted to receive a supply coil of fasteners 27 (FIG. 3) and includes an integral door 29, as generally shown in FIG. 1. Housing 22 includes a handle 28 (FIG. 1) and a compressed air mechanism (not shown) adapted to provide the pneumatic force needed to install metal piercing fasteners, such as the metal piercing fastener 33 (FIGS. 1, 2 and 13), one at a time into a stack of laminar workpieces.

Barrel portion 24 comprises a conventional fastener load mechanism 30 (FIGS. 2-3) which includes an indexing feed actuator (not shown) for advancing the fasteners into a ‘ready position’ (see FIG. 3) for firing, a fastener guide mechanism 32 (FIGS. 2, 4-6) operatively coupled to fastener load mechanism 30 (FIG. 2), and a fastener drive mechanism 34 (FIGS. 8-12) operatively coupled between the compressed air mechanism and fastener guide mechanism 32 (FIG. 2). As generally depicted in FIGS. 1-2, barrel portion 24 also comprises a generally hollow cylindrical nozzle 36 which incorporates a portion of fastener guide mechanism 32 and includes at its outer end a generally ring-shaped spring-loaded foot 38 adapted to be pressed down against a generally flat top substrate surface until a compression spring (not shown) in foot 38 is collapsed. When the power tool 20 is ready to be activated to install a fastener, the surface 39 of the foot 38 rests on the top surface of the work piece and is even with the lower surface 41 of the magazine 26, that is, the surfaces 39 and 41 are on the same plane. The surface 41 of the magazine 26 is positioned on the top surface of a work piece and provides a guide or rest useful to the operator to ensure that the fastener 33 is at a substantially right angle to the work piece before the power tool is activated. Before the foot 38 engages the surface of the work piece, it extends slightly below the surface 1 of the magazine 26. When the foot 38 is in this position, the power tool cannot be activated even if the trigger is pulled. This ensures that the tool is in a position prior to activation that will cause the fastener to enter the work piece and substrate at a substantially ninety degree (90°) angle with respect to the work piece surface. As is illustrated in the perspective view of FIG. 1, the surfaces 39 and 41 are on the same plane allowing the fastener 33 to be ejected from the nozzle 36.

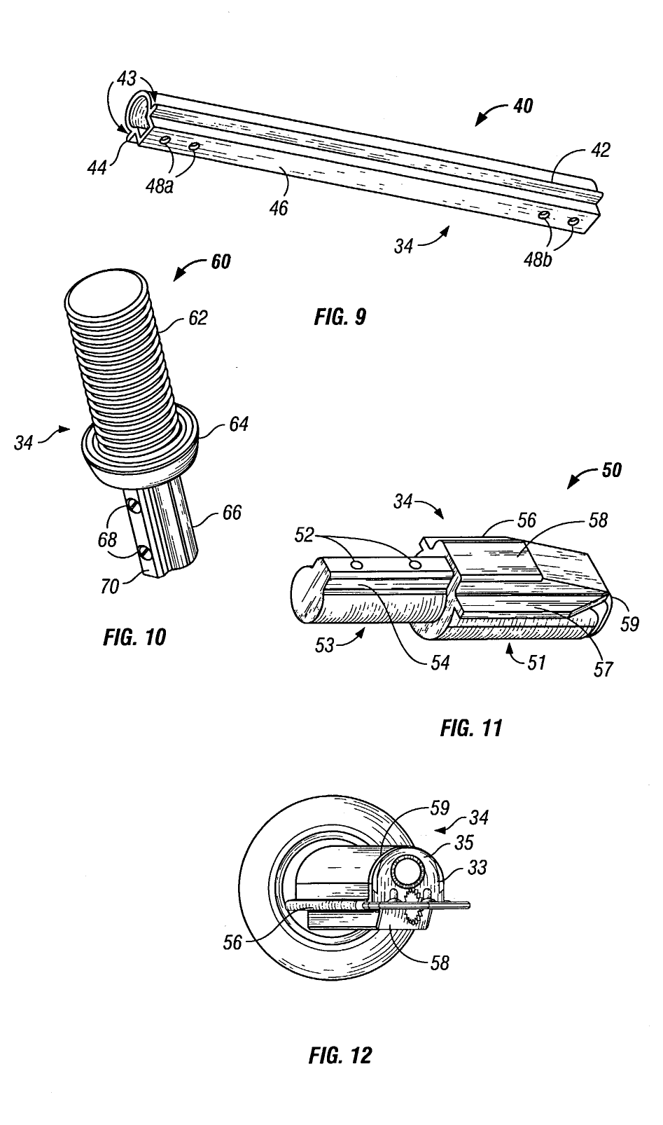

Fastener drive mechanism 34 (FIGS. 8-12) preferably comprises a generally hollow cylindrical driver body 40 (FIG. 9) which includes a generally arcuate driver head portion 43 (FIG. 9) and generally elongated outwardly protruding (right and left) side and bottom driver splines 42 and 44, and a downwardly protruding U shaped extension 46 (FIG. 9), adapted to conform generally to the outer contours of the drive channel through which the fastener is driven. Driver body 40 (FIG. 9) may be made of metal or other similar material, provided there is no departure from the intended purpose of the present invention. Fastener drive mechanism 34 also comprises a fastener driver tip 50 (FIG. 11) adapted for coupling to one end of driver body 40, and a piston attachment member 60 (FIG. 10) adapted, respectively, for coupling to an opposite end of driver body 40.

Fastener driver tip 50 is of a generally stepped configuration including raised front and recessed back portions 51-53, respectively, with recessed back portion 53 being adapted to be inserted for attachment into one end of hollow driver body 40. Attachment may be accomplished, for example, via a pair of roll pin attachment apertures 52 formed in back portion 53, a pair of roll pins (not shown), and a corresponding pair of roll pin attachment apertures 48a on protrusion 46 of driver body 40. Other means of attachment may be used provided such other attachment means do not deviate from the intended scope and spirit of the present invention.

Raised front portion 51 follows generally the outer configuration of driver body 40 by including (right and left) side and bottom driver splines, such as splines 56 (FIG. 11), 57 (FIG. 12), and 58 (FIGS. 11-12), respectively, except that the driver splines (56, 57, 58) have inwardly tapered front edges, as generally illustrated in FIGS. 11-12, to ensure non-marring of the top laminar work piece during use of pneumatic gun 20, in accordance with the general principles of the present invention. Front portion 51 includes a generally arcuate solid driver face 59 (FIG. 11) which generally follows the outer contours of crown 35, FIGS. 6 and 8 (FIG. 13) of metal piercing fastener 33 and is intended to forcibly impact crown 35 when pneumatic power tool 20 is fired, as generally depicted in FIGS. 8 and 12. Driver tip 50 is preferably fabricated from impact-resistant materials such as, for example, nickel titanium metal alloys or other similar impact resistant materials.

As generally depicted in FIG. 10, piston attachment member 60 includes a threaded front portion 62 adapted for attachment to a drive piston (not shown) operatively coupled to the air compression mechanism (of pneumatic power tool 20), a raised generally cylindrical portion 64, and a recessed back portion 66. Back portion 66 is preferably adapted to be inserted for attachment into the other end of hollow driver body 40 from where the driver tip 50 is disposed. Attachment may be accomplished, for example, via a pair of roll pin attachment apertures 68 on a bottom extension 70 (of recessed back portion 66), a pair of roll pins (not shown), and one of corresponding pairs of roll pin attachment apertures 48b on driver protrusion 46 (of driver body 40). Other means of attachment may be used provided such other attachment means do not deviate from the intended scope and spirit of the present invention.

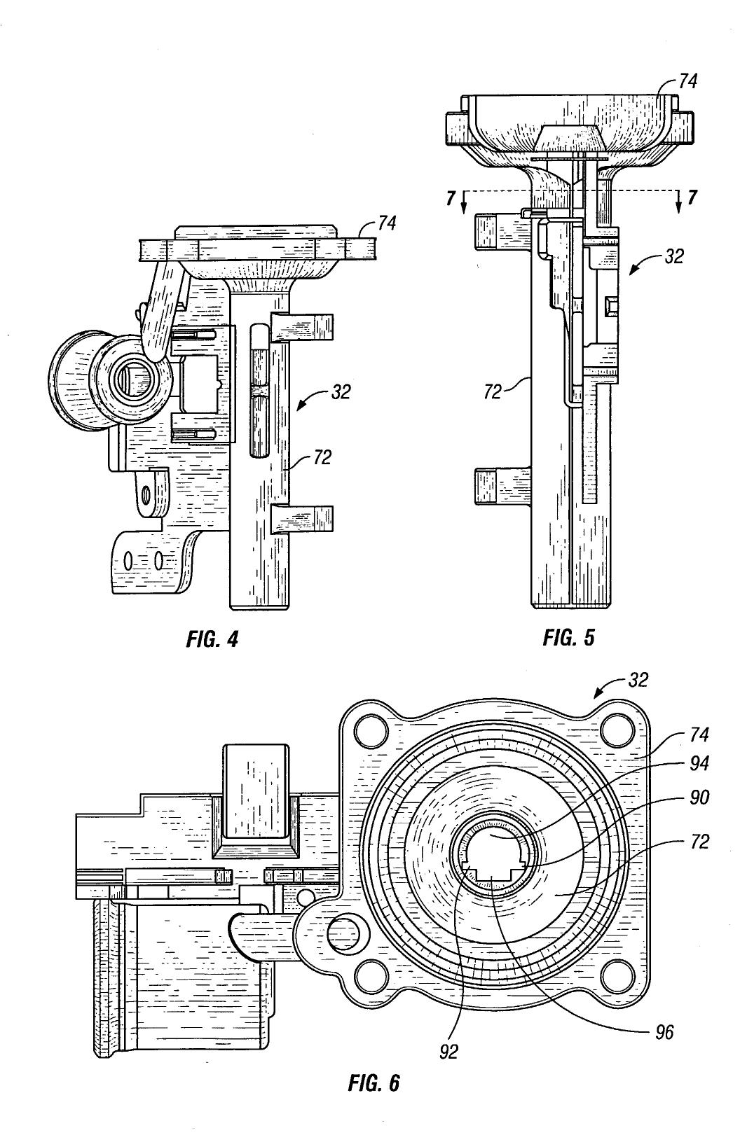

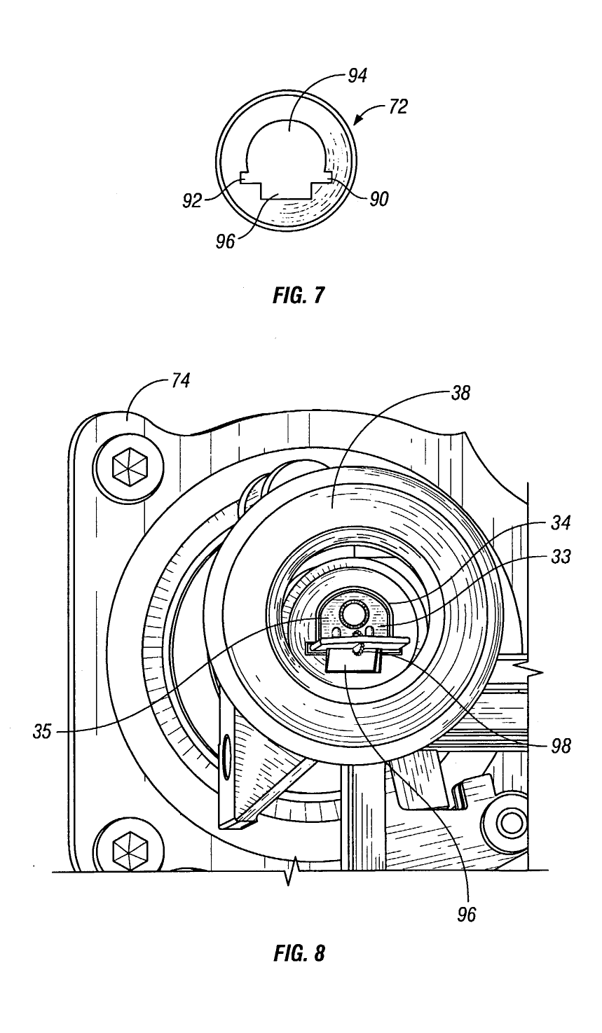

Fastener guide mechanism 32 (FIG. 2) preferably comprises a generally hollow cylindrical guide body 72 (FIGS. 4-5) which is coupled to housing 22 via a mounting flange 74 (FIGS. 2, 4-6) having a generally circular cross-section. As generally depicted in FIG. 7, guide body 72 has an internal cross-section adapted generally to accommodate the outer contours of a fastener being driven therein. For example, the outer contours of fastener 1 (FIG. 13) may be generally determined by fastener crown portion 6 which is bent relative to the body of fastener 1, right and left side guide (edge) rails 5 and 7 on the body 2 of fastener 1, and an integral tine 8 which is twisted to cause at least one portion of tine 8 to protrude outwardly from the body of fastener 1, as generally illustrated in FIG. 13. Specifically, guide body 72 is preferably provided internally with generally elongated right and left side guide channels 90-92 (FIGS. 6-7) which define a linear drive path for a fired fastener such as fastener 1 of FIGS. 17. Guide channels 90-92 are adapted to slidingly accommodate the right and left side guide rails 5 and 7 of fastener 1 (FIG. 17), as well as right and left side driver splines 42-44 of driver body 40 (FIG. 9), respectively, during operation of pneumatic power tool 20, in accordance with a preferred embodiment of the present invention.

Guide body 72 is also provided internally with a generally arcuate fastener crown clearance area 94 (FIGS. 6-7) which is adapted to clear the outer contours of a fastener crown portion, such as, for example, crown portion 80 of fastener 84 (FIG. 3), driver head portion 43 (FIG. 9), and driver face 59 of driver tip 50 (FIG. 11) during operation, in accordance with another preferred embodiment of the present invention.

Guide body 72 is further provided internally with a generally rectangular tine relief channel 96 (FIGS. 6-8) disposed generally opposite crown clearance area 94 and adapted to clear the outwardly protruding tine portion of a driven fastener such as, for example, outwardly projecting tine portion 8 of fastener 1 of FIG. 13, the outer contours of driver protrusion 46 of driver body 40 (FIG. 9), during operation, in accordance with yet another preferred embodiment of the present invention.

A person skilled in the art would recognize that all of the above-described components are easily replaceable if the need arises and that other components and/or configurations may be utilized in the above-described embodiments, provided such other components and/or configurations do not depart from the intended purpose and scope of the present invention.

While the present invention has been described in detail with regard to one or more exemplary embodiments, it should also be appreciated that various modifications and variations may be made in the present invention without departing from the scope or spirit of the invention. In this regard it is important to note that practicing the invention is not limited to the applications described hereinabove. Many other applications and/or alterations will be apparent to those skilled in the art.

It should be appreciated by a person skilled in the art that features illustrated or described as part of one embodiment may also be used in other embodiments. It is, therefore, intended that the present invention cover all such modifications, embodiments and variations as long as they come within the scope of the appended claims and their equivalents.

What is claimed is:

1. A power tool for metal piercing fasteners, comprising:
(a) a fastener guide body including at least one trajectory channel adapted to accommodate the outer contours of a metal piercing fastener, said at least one trajectory channel defining a linear drive path for said metal piercing fastener; and
(b) a fastener drive mechanism adapted to slide within said at least one trajectory channel behind said metal piercing fastener for the purpose of forcibly impacting said metal piercing fastener.

2. A power tool for metal piercing fasteners being characterized by a body bent at one end to form a crown portion and having at least one side guide rail and at least one integral tine under the crown portion, the integral tine being deformed about its longitudinal axis to cause at least one portion of the tine to protrude outwardly from the body of the fastener, said power tool comprising:
(a) a fastener guide body including at least one guide channel adapted to accommodate said at least one side guide rail of the metal piercing fastener, said at least one guide channel defining a linear drive path for the metal piercing fastener; and
(b) a fastener driver body including at least one outwardly protruding side spline adapted to conform approximately to the outer contours of said at least one side guide rail of the metal piercing fastener and to slide within said at least one guide channel behind the crown portion of the metal piercing fastener.

3. The power tool of claim 2, wherein said fastener guide body further includes at least one fastener crown clearance area adapted to clear the outer contours of the crown portion of the metal piercing fastener.

4. The power tool of claim 2, wherein said fastener guide body further includes at least one tine relief channel adapted to clear said at least one outwardly protruding tine portion of the metal piercing fastener.

5. The power tool of claim 4, wherein said fastener driver body further includes at least one outwardly protruding portion adapted to slide within said at least one tine relief channel behind the crown portion of the metal piercing fastener.

6. The power tool of claim 3, wherein said fastener driver body further includes at least one driver head portion adapted to conform approximately to the outer contours of the crown portion of the metal piercing fastener and to slide within said at least one fastener crown clearance area behind the crown portion of the metal piercing fastener.

7. A power tool for metal piercing fasteners being characterized by a body bent at one end to form a crown portion and having at least one side guide rail and at least one integral tine under the crown portion, the integral tine being deformed about its longitudinal axis to cause at least one portion of the tine to protrude outwardly from the body of the fastener, said power tool comprising:
(a) a fastener guide body including at least one guide channel adapted to accommodate said at least one side guide rail of the metal piercing fastener, said at least one guide channel defining a linear drive path for the metal piercing fastener;
(b) a fastener driver body including at least one outwardly protruding side spline adapted to conform approximately to the outer contours of said at least one side guide rail of the metal piercing fastener and to slide within said at least one guide channel; and
(c) a fastener driver tip for forcibly impacting the crown portion of the metal piercing fastener, said fastener driver tip coupled to one end of said fastener driver body and adapted to follow approximately the outer configuration of said fastener driver body.

8. The power tool of claim 7, wherein said fastener guide body further includes at least one fastener crown clearance area adapted to clear the outer contours of the crown portion of the metal piercing fastener.

9. The power tool of claim 8, wherein said fastener guide body further includes at least one tine relief channel adapted to clear said at least one outwardly protruding tine portion of the metal piercing fastener.

10. The power tool of claim 9, wherein said fastener driver body further includes at least one outwardly protruding portion adapted to slide within said at least one tine relief channel.

11. The power tool of claim 10, wherein said fastener driver body further includes at least one driver head portion adapted to conform approximately to the outer contours of the crown portion of the metal piercing fastener and to slide within said at least one fastener crown clearance area.

12. The power tool of claim 11, wherein said fastener driver tip comprises a fastener driver face for forcibly impacting the crown portion of the metal piercing fastener, said fastener driver face adapted to follow approximately the outer contours of the crown portion of the metal piercing fastener and to slide within said at least one fastener crown clearance area behind the crown portion of the metal piercing fastener.

13. The power tool of claim 12, wherein said fastener driver tip further comprises at least one bottom driver spline with a tapered front edge, said at least one tapered bottom driver spline adapted to slide within said at least one tine relief channel behind the crown portion of the metal piercing fastener.

14. The power tool of claim 12, wherein said at least one tapered side driver spline is adapted to slide within said at least one trajectory channel.

15. The power tool of claim 7, further comprising a piston attachment member coupled to another end of said fastener driver body and adapted for attachment to a driver piston.
